(19) United States
(12) Patent Application Publication
(10) Pub. No.: US 2001/0003998 A1
(43) Pub. Date: Jun. 21, 2001

(54) Heavy duty tire

(76) Inventors: Satoshi Tuda, kobe-shi (JP); Tomohiro Hashimoto, kobe-shi (JP)

Correspondence Address: BIRCH, STEWART, KOLASCH & BIRCH, LLP, P.O. Box 747, Falls Church, VA, 22040-0747, US

(21) Appl. No.: 09/736,206

(22) Filed: Dec. 15, 2000

(30) Foreign Application Priority Data
Dec. 17, 1999 (JP) 11-359533

(51) Int. Cl. B60C 11/00; B60C 11/03

(52) U.S. Cl. 152/209.9

(57) ABSTRACT

A heavy duty tire comprises a carcass extending between bead portions, and a belt layer disposed radially outside the carcass in a tread portion. The belt layer comprises a radially outmost ply and a radially inner widest ply having a belt maximum width BW in a range of from 85 to 105% of a tread width. The tread portion is provided with a pair of axially inner main grooves and a pair of axially outer main grooves, each extending continuously in the circumferential direction of the tire. The axially inner main grooves each is disposed on one side of the tire equator so that groove center lines thereof are positioned symmetrically about the tire equator, and an axial distance L2 from the tire equator to each said groove center line is in a range of from 14 to 20% a half of said maximum width BW. The axially outer main grooves each is disposed on the axially outside of one of the axially inner main grooves so that groove center lines thereof are positioned symmetrically about the tire equator, and an axial distance L1 from the tire equator to each said groove center line is in a range of from 61 to 69% a half of said maximum width BW, and an axial distance L3 from the tire equator to each edge of said radially outmost ply is smaller than said axial distance L1 and in a range of from 180 to 270% of said axial distance L2.

### BACKGROUND OF THE INVENTION

The present invention relates to a heavy duty tire which can improve an wear resistance.

A heavy duty tire which is used in a truck, a bus or the like, for example as shown in FIG. 7, comprises a toroidal carcass “a”, and the belt layer c made of steel cords and disposed radially outside the carcass “a” in a tread portion b. The tread portion b is provided with four main grooves e extending continuously in the circumferential direction of the tire. The main grooves e comprise a pair of axially inner main grooves e1 arranged in both sides of a tire equator and a pair of axially outer main grooves e2 arranged in an axially outer side of the inner main grooves e1. The main grooves e divide tread surface into a first land portion f1, a pair of second land portions f2 and a pair of third land portions f3. Each land portion f1, f2 and f3 are formed a plurality of blocks which have a high traction force even on a snow road.

However, in above tread portion b provided four main grooves e, there is a problem that there is easily generated so-called rib punch that the second land portions f2 wear one stage earlier than the first land portion f1 and the third land portions f3.

### SUMMARY OF THE INVENTION

The present invention is made by taking into consideration the problem peculiar to a heavy duty tire which is provided with four main grooves, and an object of the present invention is to provide a heavy duty tire which can control a ground pressure of each of land portions in an optimum manner and effectively prevent a rib punch or the like so as to improve an wear resistance on the basis of controlling an arrangement position of each of the main grooves, an edge of an outmost belt ply in a belt layer and the like with relation to each other.

According to one aspect of the present invention, a heavy duty tire comprising

a carcass extending between bead portions, and

a belt layer disposed radially outside the carcass in a tread portion,

said belt layer comprising

a radially outmost ply and

a radially inner widest ply having a belt maximum width BW in a range of from 85 to 105% of a tread width,

said tread portion provided with a pair of axially inner main grooves and a pair of axially outer main grooves, each extending continuously in the circumferential direction of the tire,

the axially inner main grooves each disposed on one side of the tire equator so that groove center lines thereof are positioned symmetrically about the tire equator, and

an axial distance L2 from the tire equator to each said groove center line is in a range of from 14 to 20% a half of said maximum width BW,

the axially outer main grooves each disposed on the axially outside of one of the axially inner main grooves so that

groove center lines thereof are positioned symmetrically about the tire equator, and

an axial distance L1 from the tire equator to each said groove center line is in a range of from 61 to 69% a half of said maximum width BW, and

an axial distance L3 from the tire equator to each edge of said radially outmost ply being smaller than said axial distance L1 and in a range of from 180 to 270% of said axial distance L2.

Here, the tread width TW is an axial width between the tread edges, that is, the axial outermost edges of the ground contacting region of the tire under a standard loaded condition. The standard loaded condition is that the tire is mounted on a standard rim and inflated to a standard pressure, and then loaded with a standard load. The standard rim is the “standard rim” specified in JATMA, the “Measuring Rim” in ETRTO, the “Design Rim” in T&RA or the like. The standard pressure is the “maximum air pressure” in JATMA, the “Inflation Pressure” in ETRTO, the maximum pressure given in the “Tire Load Limits at Various Cold Inflation Pressures” table in T&RA or the like. The standard load is the “maximum load capacity” in JATMA, the “Load Capacity” in ETRTO, the maximum value given in the above-mentioned table in T&RA or the like.

The widths of the outmost ply and the distances L1,L2 and L3 are measured under the standard unloaded condition in which the tire is mounted on a standard rim and inflated to a standard pressure, but loaded with no tire load.

### BRIEF DESCRIPTION OF THE DRAWINGS

FIG. 1 is a partly cross sectional view of a tire in accordance with an embodiment of the present invention.

FIG. 2 is a developed plan view showing a tread pattern thereof.

FIG. 3 is a partly enlarged cross sectional view of a tread portion.

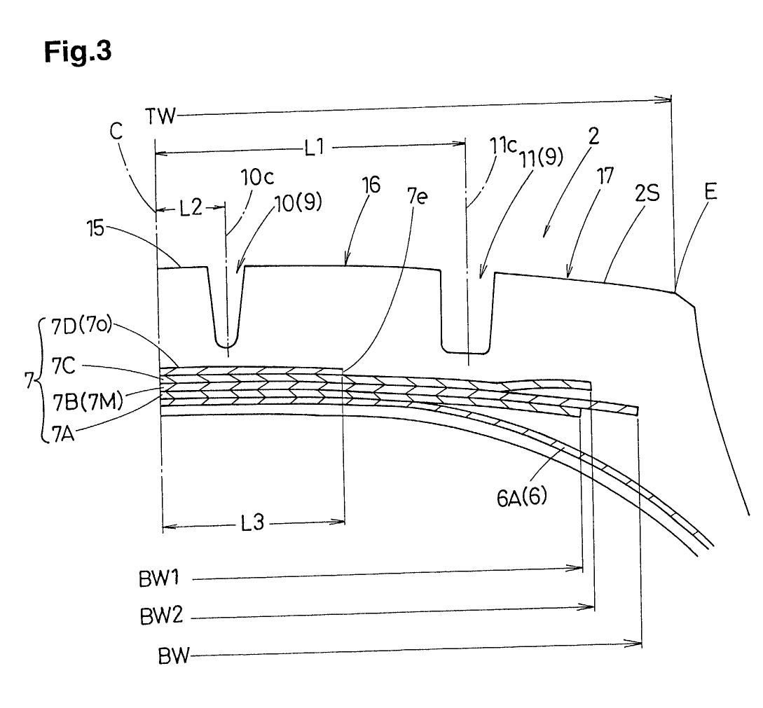

FIGS. 4A to 4C are schematic views of a ground contacting shape.

FIG. 5 is a graph showing a relation between a ground pressure ratio and a distance L2.

FIG. 6 is a graph showing a relation between a ground pressure ratio and a distance L3.

FIG. 7 is a expansion view showing a tread pattern of a conventional tire for a heavy duty tire.

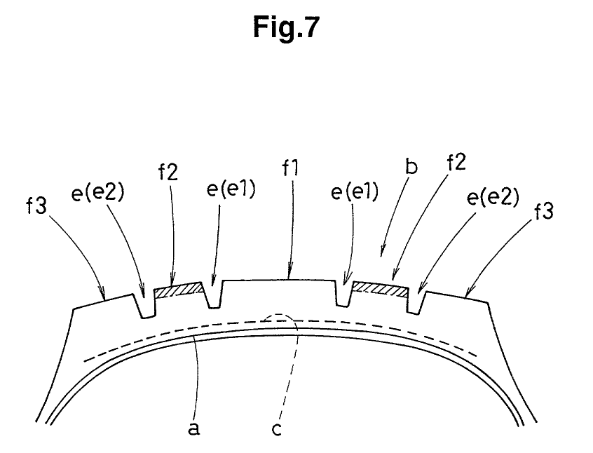

### DESCRIPTION OF THE PREFERRED EMBODIMENTS

Description of the preferred invention will now be described in detail in conjunction with the accompanying drawings.

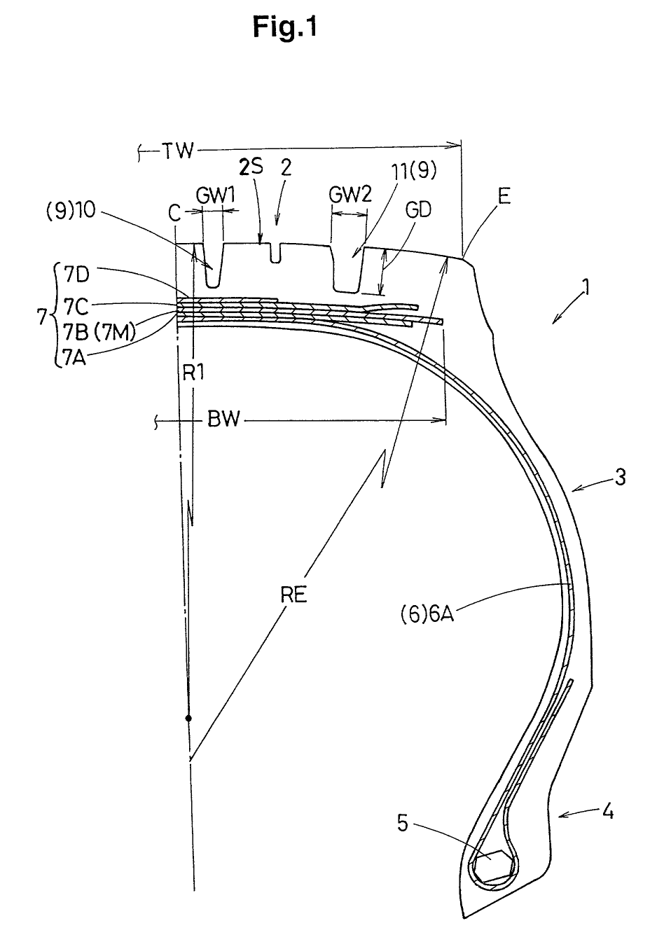

FIG. 1 is a partly cross sectional view of a heavy duty tire 1 (hereinafter, in some cases, refer simply to as “a tire”) having a tire size of 11R22.5 in accordance with the present embodiment. The tire 1 comprises a carcass 6 extending between the bead portions 4, and a belt layer 7 disposed radially outside the carcass 6 in the tread portion 2 and having a plurality of belt plies 7A,7B,7C and 7D overlapping inward and outward in the tire radial direction.

The carcass 6 is composed of at least one ply of a radial or semi-radial structure in which steel cords or organic fibers, e.g. nylon, rayon, polyester, aromatic polyamide and the like are laid at an inclination angle range of from 70 to 90 degrees with respect to the tire equator C. In this embodiment, it is composed of a single ply 6A with a pair of turnup portions each turned up around the bead core 5 from the axially inside to the outside of the tire and composed steel cords inclined at an angle of 90 degrees with respect to the tire equator C.

In this embodiment, the belt layer 7 comprises four plies of steel cords, in which the radially innermost ply 7A is composed of steel cords laid in parallel with each other at an angle of 60 degrees plus minus 10 degrees with respect to the tire equator C, and each of the remaining plies 7B, 7C and 7D is composed of steel cords laid in parallel with each other at an angle of not more than 30 degrees with respect to the tire equator C. The cords in each ply are crosswise to those of the next ply. Further, in this embodiment the inner belt ply 7B arranged radially inside the outmost ply 7D is widest ply 7M having a belt maximum width BW.

Then, the width of the widest ply 7M, that is, the belt maximum width BW is in a range of from 85 to 105% of a tread width TW. When the belt maximum width BW is less than 85% of the tread width TW, a rigidity in an edge side of the tread becomes insufficient and a shoulder wear or the like is easily generated, and on the contrary, when it becomes over 105%, an edge of the belt layer 7 closes to a buttless surface of the tire and a crack or the like is easily generated, and an uneven wear is easily caused.

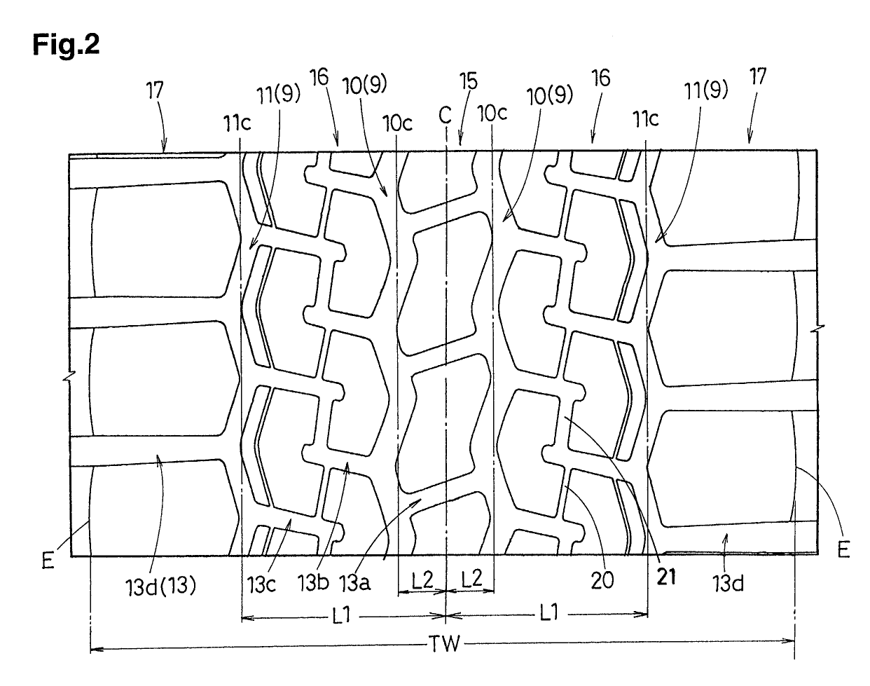

The tread portion 2 is provided with four main grooves 9 extending continuously in the circumferential direction of the tire. The main grooves 9 comprise a pair of axially inner main grooves 10 and a pair of axially outer main grooves 11. The inner main grooves 10 each is disposed on one side of the tire equator C so that groove center lines 10c thereof are positioned symmetrically about the tire equator C as shown in FIG. 2. The outer main grooves 11 each also is disposed on one side of the tire equator C so that groove center lines 11c thereof are positioned symmetrically about the tire equator C as shown in FIG. 2.

In this embodiment, each of the main grooves 10 and 11 is formed in a zigzag shape along the circumferential direction of the tire, however, various kinds of shapes such as a straight shape or a sine curve shape can be applicable.

Further, in the tread portion 2, in accordance with the present embodiment, is formed a first land portion 15 between the inner main grooves 10, a pair of second land portions 16 between the inner main grooves 10 and the outer main grooves 11, and a pair of third land portion 17 between the outer main grooves 11 and the tread edges E, respectively. In accordance with the present embodiment, at least one axial grooves 13 are formed in each of the first to third land portions 15, 16 and 17.

In this embodiment, the axial grooves 13 comprise, for example, first axial grooves 13a extending between the inner main grooves 10, second axial grooves 13b extending from the inner main grooves 10 to axially outside of the tire and intermittently finishing without being connected with the outer main groove 11, a third axial grooves 13c extending from the outer main grooves 11 to axially inside of the tire and intermittently finishing without being connected with the inner main grooves 10, and a fourth axial grooves 13d extending between the outer main grooves 11 and the tread edges E. In this case, the second and third axial grooves 13b and 13c are connected by a narrow groove 20 and a wide groove 21 mutually each extending in the circumferential direction of the tire. Accordingly, the tire in accordance with the present embodiment is shown in which both of the first land portion 15 and the third land portions 17 each are formed in a plurality of blocks and the second land portions 16 is formed in a rib-like shape substantially connected via the narrow grooves 20 and the wide grooves 21.

A groove widths GW1 and GW2, a groove depth GD of the main grooves 9 (all are shown in FIG. 1) can be variously set as occasion demands. For example, the groove widths GW1 and GW2 of the main grooves 9 are preferably set to widths equal to or more than 2% the tread width TW, more preferably set to be equal to or more than 3% thereof, and at least set to be equal to or more than 6 mm. Further, the groove depth GD of the main groove 9 is, for example, desirably set to 5 to 12% the tread width TW. In this case, the groove width of each of the axial grooves 13 is desirably set to, for example, be equal to or more than 2% the tread width TW, and the groove depth of the axial groove 13 is desirably set to, for example, be 2 to 12% the tread width TW.

Further, in this embodiment, a tread surface 2S is formed by connecting a plurality of arcs obtained by gradually reducing a radius of curvature into axially outside of the tire. The tread surface 2S is formed by a central arc passing through the tire equator C and having a radius of curvature R1 (shown in FIG. 1) of about 800 to 1200 mm, a pair of axially outer arcs passing through the tread edges E and having a radius of curvature RE of about 300 to 400 mm, and a plurality of middle arcs connecting between the center arc and the outer arc. The middle arcs comprise, for example, three to seven kinds of arcs which gradually reduce the radius of curvature into the axially outside of the tire.

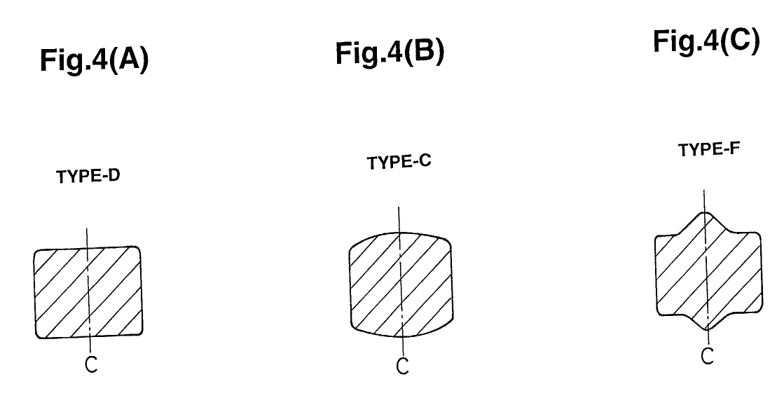

In this case, in accordance with various kinds of experiments by the inventors of the present application, on investigation of a ground contact shape of the tire in which a rib punch of the second land portion 16 is easily generated, it has been known that the ground contact shape is formed in a distorted shape that a crown portion largely protrudes in forward and backward the circumferential direction of the tire (hereinafter, this kind of ground contact shape is sometimes called as a “type-F”), as shown in FIG. 4C in an exaggerative manner. The type-F ground contact shape is based on the matter that the ground pressure of the first land portion 15 is significantly greater than the ground pressure of the third land portion 17 and the matter that the ground pressure of the second land portion 16 is significantly smaller than the ground pressure of the third land portion 17.

Further, among the various kinds of trials, there can be obtained a tire having a ground contact shape formed in a rectangular shape as shown in FIG. 4A (hereinafter, this kind of ground contact shape is sometimes called as a “type-D”), however, in this tire, there is shown a so-called center wear that the first land portion 15 wears earlier. Then, as a result of further performing various kinds of experiments, as shown in FIG. 4B, in a tire having an oval-shaped ground contact shape in which front and rear edges in the circumferential direction of the tire protrude outward so as to form a smooth circular arc shape (hereinafter, this kind of ground contact shape is sometimes called as a “type-C”), the ground pressure of each of the land portions 15 to 17 can be balanced and each of the land portions evenly can be worn, so that it is known that a wear resistance can be improved. Then, in accordance with the present invention, in order to obtain the type-C ground contact shape mentioned above, arranged positions of the inner main grooves 10 and the outer main grooves 11, a position of an edge of the outmost belt ply 7D and the like are designed with respect to the belt maximum width BW or the like, as mentioned below.

At first, an axial distance L1 from the tire equator C to each the groove center line 11c of the outer main grooves 11 is in a range of from 61 to 69% a half of said maximum belt width BW, and an axial distance L2 from the tire equator C to each groove center line 10c of the inner main grooves 10 is in a range of from 14 to 20% the half of said maximum belt width BW. Each of the groove center lines 10cand 11c of the respective main grooves is a straight lines passing through the center of the groove width, however, in the case that the main grooves 10 and 11 are formed in a zigzag shape as in the present embodiment, the groove center line is set to a straight line passing through a center of an amplitude of the groove width center line of the zigzag shape and formed along the circumferential direction of the tire.

When the distance L1 is less than 61% the half of the belt maximum width BW, the outer main grooves 11 moves close to the side of tire equator C, so that a rigidity of the second land portion 16 becomes insufficient and a rib punch wear is generated in the second land portion 16, and there is a tendency that an edge wear is generated in the second land portion side of the land portions 15 and 17 in both sides thereof. On the contrary, when the distance L1 is over 69% the half of belt maximum width BW, a rigidity of the third land portion 17 becomes insufficient and a uneven wear is easily generated in the third land portion 17.

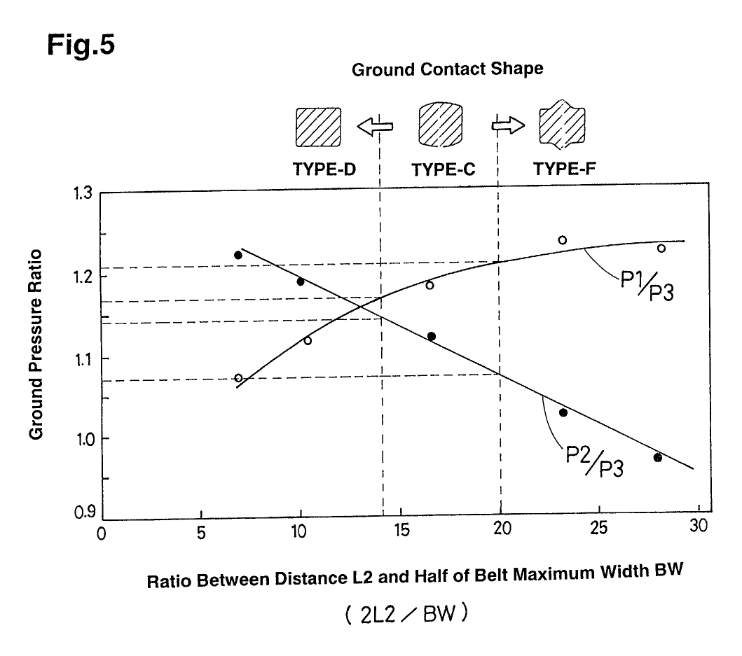

Further, the inventors of the present application manufactures for trial a tire (a tire size 11R22.5) obtained by variously changing the distance L2, measures a ground pressure P1 of the first land portion 15, a ground pressure P2 of the second land portion 16 and a ground pressure P3 of the third land portion 17, and investigates a ground contact shape. FIG. 5 shows a graph obtained by setting a vertical axis to a ground pressure ratio of (P1/P3) and (P2/P3), a horizontal axis in a lower stage to a ratio (2×L2/BW) between a half of the belt maximum width BW and the distance L2 and a horizontal axis in an upper stage to a ground contact shape. In this case, each of the ground pressures is measured at a ground contact center position of each of the land portions in the standard loaded condition.

As is apparent from FIG. 5, in order to obtain the type-C ground contact shape, it is necessary to set the distance L2 mentioned above to 14 to 20% the half width of the belt maximum width BW. If the distance L2 mentioned above becomes less than 14% the half width of the belt maximum width BW, the ground pressure P1 of the first land portion 15 is relatively reduced and the ground pressure P2 of the second land portion 16 is relatively increased, whereby the ground contact shape becomes close to the type-D mentioned above. Accordingly, uneven wear such as the center wear is easily generated in the first land portion 15. Further, when the distance L2 is over 20% of the half width of the belt maximum width BW, as is inverse to the matter mentioned above, the ground pressure P1 of the first land portion 15 is relatively increased and the ground pressure P2 of the second land portion 16 is relatively reduced, whereby the ground contact shape becomes close to the type-F mentioned above, so that it is impossible to solve the problem that the rib punch is generated in the second land portion 16.

As is apparent from FIG. 5, in order to form the ground contact shape of the tire in the preferable type-C mentioned above, it is desirable that the ground pressure ratio in each of the land portions, that is, the ratio among the ground pressure P1 of the first land portion 15, the ground pressure P2 of the second land portion 16 and the ground pressure P3 of the third land portion 17 satisfies the following conditions:

1.17=<P1/P3=<1.21

and

1.07=<P2/P3=<1.14.

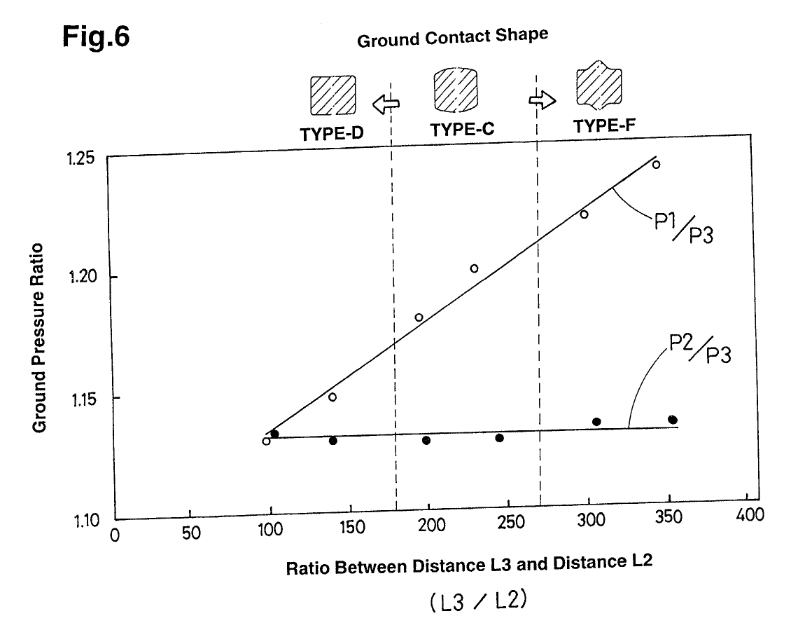

Further, as a result of the experiments by the inventors of the present application, it has been known that the ground contact shape is changed by changing the position of the edge 7e of the outmost belt ply 7D even in the case of restricting the respective groove center lines 10c and 11c of the inner main grooves 10 and the outer main grooves 11 to a range mentioned above. FIG. 6 shows a graph obtained by setting a vertical axis to the ground pressure ratio of (P1/P3) and (P2/P3), a horizontal axis in a lower stage to a ratio (L3/L2) between an axial distance L3 and the distance L2 and a horizontal axis in an upper stage to the ground contact shape. Here, the distance L3 is an axial distance from the tire equator C to each edge 7e of the radially outmost ply 7D. The ground pressure is measured in the same manner as mentioned above.

As is apparent from FIG. 6, it has been known that in the case of fixing the distance L2 and changing the distance L3, the ground pressure ratio (P2/P3) between the third land portion 17 and the second land portion 16 is hardly changed, however, the ground pressure ratio (P1/P3) between the first land portion 15 and the third land portion 17 is increased substantially in proportional to the distance L3, thereby excessively increasing the ground pressure P1 of the first land portion 15 with respect to the ground pressure P3 of the third land portion 17. Since a level difference of rigidity is generally generated at the position of the edge 7e of the outmost belt ply 7D in the belt layer 7, a bending amount to an inner side in the tire radial direction is increased in an outer side in the axial direction from the edge 7e. Accordingly, the ground pressure in the side of the tire center portion is relatively increased as extending the edge 7e of the outmost belt ply 7D to the outer side in the tire axial direction.

Further, in accordance with FIG. 6, it has been known that in order to form the ground contact shape of the tire in the type-C, it is necessary to set the distance L3 mentioned above to 180 to 270%,for example more preferably 200 to 230%, the distance L2 mentioned above. When the distance L3 becomes less than 180% of the distance L2, the ground pressure P1 of the first land portion 15 is relatively reduced with respect to the ground pressure P3 of the third land portion 17, the ground contact shape is changed close to the type-D mentioned above and the uneven wear such as the center wear is easily generated. On the contrary, when the distance L3 mentioned above is over 270% the distance L2, the rigidity of the second land portion 16 is reduced, the ground contact shape becomes close to the type-F mentioned above and the rib punch is easily generated in the second land portion 16.

As mentioned above, the heavy duty tire in accordance with the present invention can control the ground pressure of the land portion in the tire in an optimum manner and make the ground contact shape close to the type-C which is optimum with respect to an wear characteristic, by not only individually restricting the arranged positions of the main grooves 9 in a simple manner but also restricting the positions thereof, the belt maximum width BW of the belt ply, the position of the outer end 7e of the outmost belt ply 7D and the like in such a manner as to apply relation to each other. Accordingly, it is possible to improve a wear resistance of the tire. In this embodiment mentioned above, the structure is made such that both of the first land portion 15 and the third land portion 17 are constituted by the blocks, however, the present invention is not limited to the embodiment mentioned above, and the structure is made such that any one or all of them are constituted by ribs continuously extending in the circumferential direction of the tire. In this case, the widths BW1 and BW2 of the other plies 7A and 7C in the belt layer 7 are set to substantially 83 to 95% of the belt maximum width BW and more preferably set to 85 to 93%.

Next, a description will be given of an embodiment obtained by more particularly structuring the present invention.

A heavy duty radial tires for all seasons having the structure shown in FIG. 1, the basic structure and pattern shown in FIG. 2 and a tire size of 11R22.5 14PR are manufactured by way of trial experiment on the basis of a specification in Table 1, and the tires are tested with respect to a ground contact shape and an wear resistance.

The ground contact shape of the tire is estimated by mounting each of the tires to be tested to a rim having a size of 22.5×7.50 with an internal pressure 700 kPa, pressing to a flat surface with a vertical load 26.72 kN, investigating an outer peripheral contour of the ground contact shape and classifying to the closest shape among FIGS. 4A to 4C. Further, the wear resistance is observed by mounting each of the tires to be tested to a rim having a size of 22.5×7.50 with an internal pressure 700 kPa, attaching to a front wheel in a 2-D/4 fixed load vehicle for loading 20 tons, and seeing an wear condition of the tread surface after the vehicle runs for 20000 km. The result of test is shown in Table 1.

TABLE 1

| | Comp- | | Comp- | Comp- | | Comp- |
|---|---|---|---|---|---|---|
| | arative | | arative | arative | | arative |
| | Exam- | Embod- | Exam- | Exam- | Embod- | Exam- |
| | ple 1 | iment 1 | ple 2 | ple 3 | iment 2 | ple 4 |
| BW/TW (%) | 97 | | | | | |
| L1/BW (%) | 63 | 63 | 63 | 63 | 63 | 63 |
| L2/BW (%) | 10 | 17 | 28 | 17 | 17 | 17 |
| L3/L2 (%) | 200 | 200 | 200 | 100 | 230 | 350 |
| Ground | Type-D | Type-C | Type-F | Type-D | Type-C | Type-F |
| contact | | | | | | |
| Shape | | | | | | |
| (FIG. 4) | | | | | | |
| Wear | Center | Even | Rib | Center | Even | Rib |
| Condition | Wear | Wear | Punch | Wear | Wear | Punch |
| | Of First | | Of | Of First | | Of |
| | Land | | Second | Land | | Second |
| | Portion | | Land | Portion | | Land |
| | | | Portion | | | Portion |

As a result of the tests, all of the tires in accordance with the embodiment have the type-C ground contact shape and even wear condition, so that a good result can be obtained.

As mentioned above, the heavy duty tire in accordance with the present invention can make the ground contact shape of the tire optimum, evenly abrade the tread surface with an improved balance and the like by restricting the arranged position of the main groove, the belt maximum width of the belt ply, the outer end position of the outer belt ply and the like with relation to each other, so that it is possible to restrict an uneven wear and improve an wear resistance.

1. A heavy duty tire comprising
a carcass extending between bead portions, and
a belt layer disposed radially outside the carcass in a tread portion,
said belt layer comprising
a radially outmost ply and
a radially inner widest ply having a belt maximum width BW in a range of from 85 to 105% of a tread width,
said tread portion provided with a pair of axially inner main grooves and a pair of axially outer main grooves, each extending continuously in the circumferential direction of the tire,
the axially inner main grooves each disposed on one side of the tire equator so that
groove center lines thereof are positioned symmetrically about the tire equator, and
an axial distance L2 from the tire equator to each said groove center line is in a range of from 14 to 20% a half of said maximum width BW,
the axially outer main grooves each disposed on the axially outside of one of the axially inner main grooves so that
groove center lines thereof are positioned symmetrically about the tire equator, and
an axial distance L1 from the tire equator to each said groove center line is in a range of from 61 to 69% a half of said maximum width BW, and
an axial distance L3 from the tire equator to each edge of said radially outmost ply being smaller than said axial distance L1 and in a range of from 180 to 270% of said axial distance L2.

2. The heavy duty tire according to claim 1, wherein,
in a standard loaded condition of the tire, said tread portion has a ground pressure distribution which satisfies the following conditions:
1.17=<P1/P3=<1.21
and
1.07=<P2/P3=<1.14
wherein
P1 is a ground pressure between the axially inner main grooves,
P2 is a ground pressure between the axially inner main grooves and axially outer main grooves, and
P3 is a ground pressure between the axially outer main grooves and tread edges.
